(19) United States
(12) Patent Application Publication
(10) Pub. No.: US 2012/0183383 A1
(43) Pub. Date: Jul. 19, 2012

(54) Mechanism and method of operation for polymorphic tracked vehicles such that the vehicle's weight can be spread between multiple supporting wheels

(76) Inventor: Rustam Stolkin, London (GB)

(21) Appl. No.: 13/244,566

(22) Filed: Sep. 25, 2011

Related U.S. Application Data
(60) Provisional application No. 61/386,521, filed on Sep. 26, 2010.

(51) Int. Cl. B62D 55/06; B62D 55/075

(52) U.S. Cl. 414/729; 180/9.52

(57) ABSTRACT

A method and apparatus is disclosed, for construction and operation of an all terrain polymorphic tracked vehicle. This invention extends and improves on the prior art disclosed in USPTO patent pending “A polymorphic tracked vehicle”, filed August 2009, USPTO application Ser. No. 12/540,391. The improvement concerns a mechanism and method of operation by which a track mechanism can be polymorphic, but can also distribute the weight of the vehicle over multiple supporting wheels. In contrast, in most configurations of the mechanism disclosed in application Ser. No. 12/540,391, the weight of the vehicle rests on just two wheels per track (i.e. on four wheels if the vehicles possesses a left track and a right track).

### CROSS REFERENCE TO RELATED APPLICATIONS

This application claims the benefit of Provisional Patent Application Ser. No. 61/386,521 filed 2010 Sep. 26 by the present inventor, which is incorporated by reference.

### STATEMENT REGARDING FEDERALLY SPONSORED RESEARCH

Not applicable.

### FIELD OF THE INVENTION

The present invention relates to the field of tracked vehicles, sometimes also known as tractor crawlers, track-type tractors or track-laying vehicles (i.e. vehicles that run on tracks instead of wheels). In particular, the invention involves a “polymorphic” track mechanism by which a vehicle's tracks may be made to change shape. Comparable mechanisms in the prior art are sometimes referred to as articulated, variable geometry or variable configuration track mechanisms, in which a vehicle's tracks can be made to take up multiple configurations, having different geometries.

### BACKGROUND OF THE INVENTION

Tracked vehicles are known to be advantageous for negotiating rough terrain and load bearing. Such vehicles are useful in applications such as military, agricultural or construction vehicles. It is also possible to employ remotely operated or autonomous robotic tracked vehicles in situations where it is dangerous to use a manned vehicle or to deploy a human pedestrian. Such applications include bomb disposal, some rescue operations, monitoring and materials handling in radioactive or otherwise hazardous environments, or the military deployment of remote weapons platforms, for example robot vehicles carrying remotely operated weapons turrets. Military requirements for such weapons deploying robots call for extreme obstacle negotiating capabilities, including the capability to ascend steep stairs. It is also advantageous for full size, heavy duty vehicles, to be able to negotiate extreme terrain.

The use of conventional track mechanisms in such applications is limited, in that different situations may best be tackled with different shapes of track profile. For example, when driving up a steep staircase, it is advantageous for a robot to have a long tracked base and a low center of gravity, to avoid the robot toppling over backwards. Likewise, for a full size self propelled howitzer (large artillery weapon on tracks), it is also advantageous to have a long wheel base or tracked base and a low center of gravity, to minimize the effects of recoil when the weapon is discharged. In contrast, when driving over rough terrain, it may be advantageous to have high ground clearance, necessitating a comparatively high center of gravity. It would therefore be advantageous to have a single vehicle for which the shape of the tracks could be varied during operation.

Additionally, when operating a vehicle mounted weapons or surveillance turret, problems may arise when the vehicle is on inclined terrain, as the plane in which the turret pans may become skewed to the horizontal. In such instances it would be desirable to have a vehicle with a self leveling mechanism, whereby the main body of the vehicle, and hence the plane of a turret, mounted thereon, could be leveled with respect to the horizon.

The present invention comprises a novel polymorphic track mechanism, whereby it is possible to vary the shapes of the tracks during operation. Furthermore, since it is possible to vary the shapes (and hence the depths) of the left and right tracks independently of each other, this invention enables such a vehicle to be operated so as to effect self leveling.

USPTO patent pending “A polymorphic tracked vehicle”, filed August 2009, USPTO application Ser. No. 12/540,391, describes an actuated track system, whereby the shape of the tracks can be varied during operation. Each track can be controlled so as to change between a configuration with a long wheel-base or tracked base with a low center of gravity, and other configurations where the track adopts a trapezoidal shape with a comparatively high ground clearance. A difficulty with this design, is that in tracked vehicle engineering, it is usually desirable to distribute the weight of the vehicle as evenly as possible over the length of track which is in contact with the ground. In contrast, the vehicle of patent application 12540391 is limited in that, in all but the longest wheel-base configuration, the entire weight of the vehicle rests on just two wheels or sprockets per track (i.e. the weight of the vehicle rests on four wheels when the vehicle comprises both a left and a right track).

It would be advantageous if a polymorphic vehicle could be built, which possesses the useful shape changing track capabilities of the vehicle described in patent application Ser. No. 12/540,391, but which also enables the weight of the vehicle to be distributed over more than two wheels per track. This document describes an inventive mechanism and method of operation, by which a polymorphic tracked vehicle can be built, in which the tracks can be actuated to adopt many different trapezoidal configurations (in similar fashion to that described in application Ser. No. 12/540,391), but for which the weight of the vehicle can be distributed between at least three (and in general arbitrarily many) wheels or track sprockets for each track, regardless of the track shape or configuration which is selected by the operator.

### DESCRIPTION OF PRIOR ART

There are a variety of mechanisms described in the prior art that address the problem of climbing stairs and negotiating various other obstacles, using tracked vehicles. Several of these methods, such as those disclosed in U.S. Pat. No. 3,869,011 - - - Jensen (1973) and U.S. Pat. No. 4,709,773 - - - Clement and Villedieu (1986), involve the use of multiple tracked bodies, and an untracked body (often a seat or platform), articulated about a common axis. Motors are used to rotate these articulated bodies with respect to each other, thereby presenting different possible vehicle geometries to encountered obstacles. Another mechanism is disclosed in U.S. Pat. No. 6,431,296 B1 - - - Won (2001), which consists of a vehicle equipped with a main pair of tracks, comprising the rear section of the vehicle, and a smaller, auxiliary pair of tracks (sometimes referred to in related literature as “flippers”) comprising the forward section of the vehicle, the rear and forward sections being articulated about a common axis. The orientation of the flippers can be manipulated, in order to facilitate climbing stairs and other obstacles. In contrast, the present invention utilizes only a single track on either side of the vehicle, but this track is “polymorphic” in that it can be made to change shape.

The prior art also discloses embodiments of mechanisms that enable a single track to change shape. U.S. Patent No. 2004/0239092 A1 - - - Haringer (2004), describes a crawler-tracked vehicle with variable track width for use in construction and agriculture. U.S. Patent No. 2007/0029117 A1 - - - Goldenberg and Lin (2007), describes a variable configuration articulated tracked vehicle which can be used to overcome obstacles such as climbing stairs or crossing trenches. In both of these methods, the shape of each track is essentially triangular. The three vertices of the triangular track shape are supported by a driving wheel, a supporting wheel and a deflecting wheel respectively. Additional supporting wheels may also be incorporated. In U.S. Patent No. 2007/0029117 A1, the deflecting wheel is moved in such a way as to modify the triangular shape of the track without changing the overall track length. In U.S. Patent No. 2004/0239092 A1, the deflecting wheel is moved, but the distance between the driving wheel and the supporting wheel is also simultaneously varied in order to produce a change in track shape. In contrast to both U.S. Patent No. 2004/0239092 A1 and U.S. Patent No. 2007/0029117 A1, our previous invention, described in USPTO patent pending “A polymorphic tracked vehicle”, filed August 2009, USPTO application Ser. No. 12/540,391, comprises a polymorphic track mechanism in which the track takes up a trapezoidal shape, the track being supported by four wheels, one wheel at each of the corners of the trapezoid. The four wheels include a pair at the front of the vehicle and a pair at the back of the vehicle. Each such pair is mounted on opposite ends of an arm which can be rotated about its center. Rotating these arms causes the shape of the trapezoidal track locus to be altered (moving the two parallel sides of the trapezoid either closer together or further apart). Thus, our invention of USPTO application Ser. No. 12/540,391, comprises a substantially different mechanism from both U.S. Patent No. 2004/0239092 A1 and U.S. Patent No. 2007/0029117 A1. Note that none of the prior art discussed above describes track mechanisms which may be operated so as to effect self leveling of the vehicle's main body when the vehicle is on inclined terrain, and so this is also a novel feature of our previous invention, USPTO application Ser. No. 12/540,391 (hereafter described as “the Ser. No. 12/540,391 vehicle”).

The present invention, disclosed herein, extends and improves upon the Ser. No. 12/540,391 vehicle, in that it provides a mechanism whereby the weight of the vehicle can be distributed over arbitrarily many wheels or track sprockets, while still retaining the useful shape changing properties of the Ser. No. 12/540,391 vehicle.

### BRIEF DESCRIPTION OF THE DRAWINGS

For a more complete understanding of the present invention, reference is made to the following detailed description of various exemplary embodiments considered in conjunction with the accompanying drawings.

FIG. 1, FIG. 2, FIG. 3, FIG. 4, FIG. 5 all show embodiments of the prior art disclosed in USPTO patent application Ser. No. 12/540,391 “A polymorphic tracked vehicle”, filed in August 2009. It is instructive to show this prior art here, because the present invention builds on and extends certain mechanisms which are fundamental to the Ser. No. 12/540/391 invention. Therefore some illustration of the Ser. No. 12/540,391 vehicle is necessary for proper understanding of the workings of the present invention. FIG. 6, FIG. 7, FIG. 8, FIG. 9, FIG. 10, FIG. 11, FIG. 12, show several variations of an inventive mechanism and method of operation, by which a polymorphic vehicle can be built and operated. These inventive mechanisms are similar to that described in application Ser. No. 12/540,391, but have the additional property that the weight of the vehicle can be distributed over at least three wheels or track sprockets per track, at all times.

FIG. 1 shows a prototype polymorphic tracked vehicle, which is one possible embodiment of the Ser. No. 12/540,391 vehicle. Features of the invention that are visible in this figure include:

1) a vehicle chassis comprising a main body;

2) a right track;

3) a left track;

4) a front actuated arm on the right side of the vehicle;

5) a rear actuated arm on the right side of the vehicle;

6) a rear actuated arm on the left side of the vehicle (partially obscured by vehicle main body);

7) a front actuated arm on the left side of the vehicle (partially obscured by vehicle main body);

8) wheels, rotatably attached to actuated arms, that engage with and support the tracks, which are henceforth sometimes referred to as “track sprockets”.

FIG. 2A shows a simplified diagram of the right track of the Ser. No. 12/540,391 vehicle as viewed from the right side of the vehicle. Features of the invention that are visible in this figure include:

1) a vehicle chassis comprising a main body;

2) a right track;

4) a front actuated arm on the right side of the vehicle;

5) a rear actuated arm on the right side of the vehicle;

8) wheels, rotatably attached to actuated arms, that engage with and support the tracks, which are henceforth sometimes referred to as “track sprockets”.

FIGS. 2A, 2B, 2C, 2D and 2E show various different track shapes that can be achieved by rotating the actuated arms. We sometimes refer to the profile of FIG. 2A as “tank” profile, FIG. 2C as “extended” profile, and FIG. 2E as “box” profile.

FIG. 3A to FIG. 3E show how the different configurations of the polymorphic tracks can be used to enable a polymorphic tracked vehicle to climb a flight of stairs or other obstacles. In FIG. 3A the “tank” profile is used to approach and engage the bottom step. In FIG. 3B the actuated arms are rotated, levering the vehicle onto the stairs and converting to the “extended” profile in FIG. 3C. The extended profile provides a long tracked base and low center of gravity which enables the vehicle to climb steep stairs without toppling.

FIG. 4A and FIG. 4B together illustrates how a self leveling capability (an ability to control the angle of the vehicle chassis or body relative to the ground) of the polymorphic tracked vehicle results from the ability to independently vary the shapes of the left and right tracks. FIG. 4A and FIG. 4B show front side views of a possible embodiment of the invention. Features of the invention that are visible in this figure include:

1) a vehicle chassis comprising a main body;

2) a right track;

3) a left track;

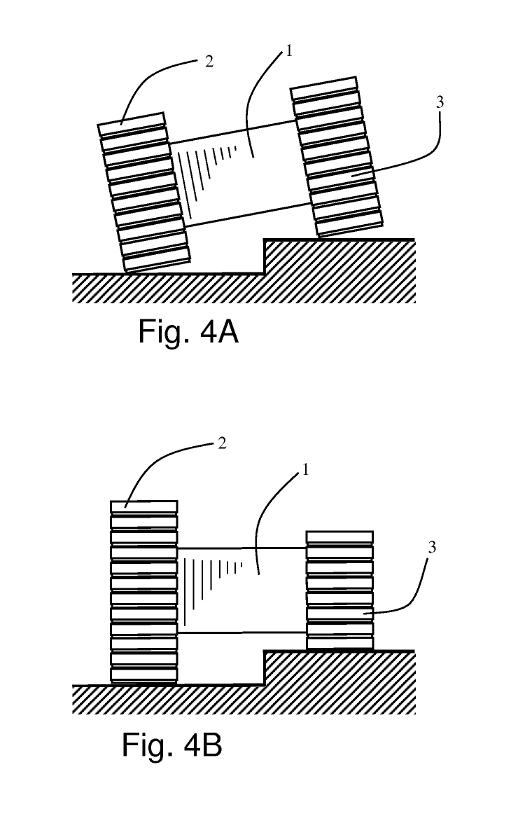

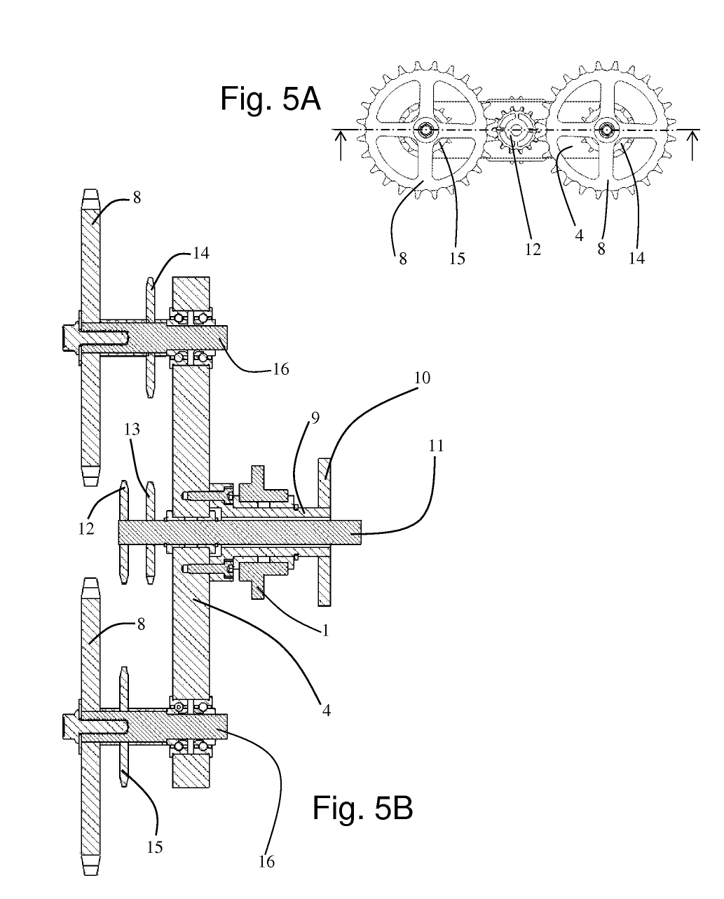

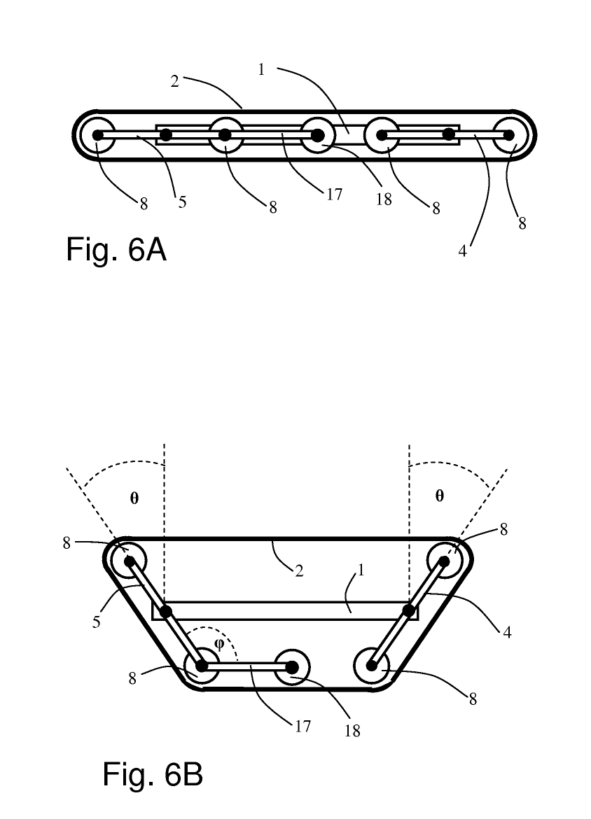

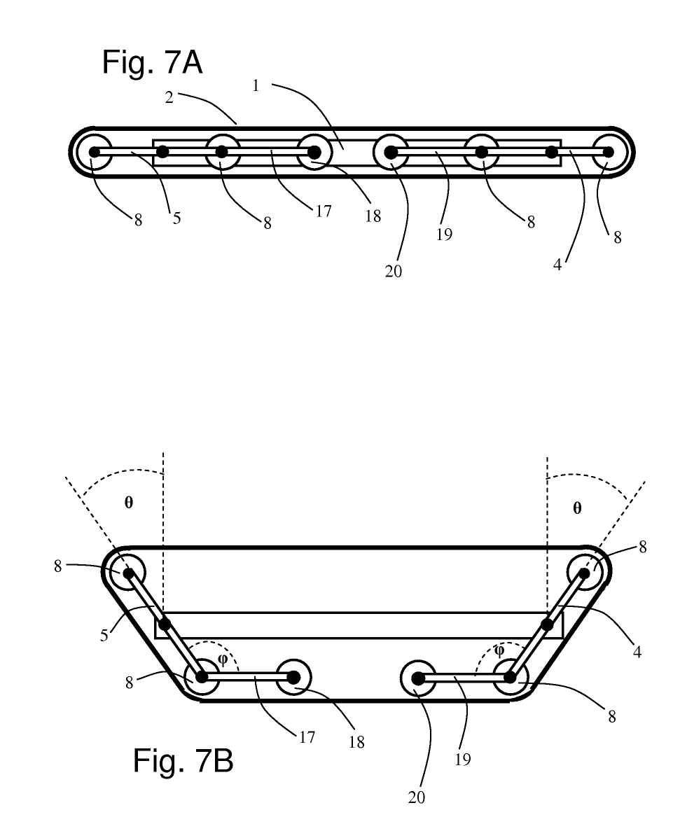

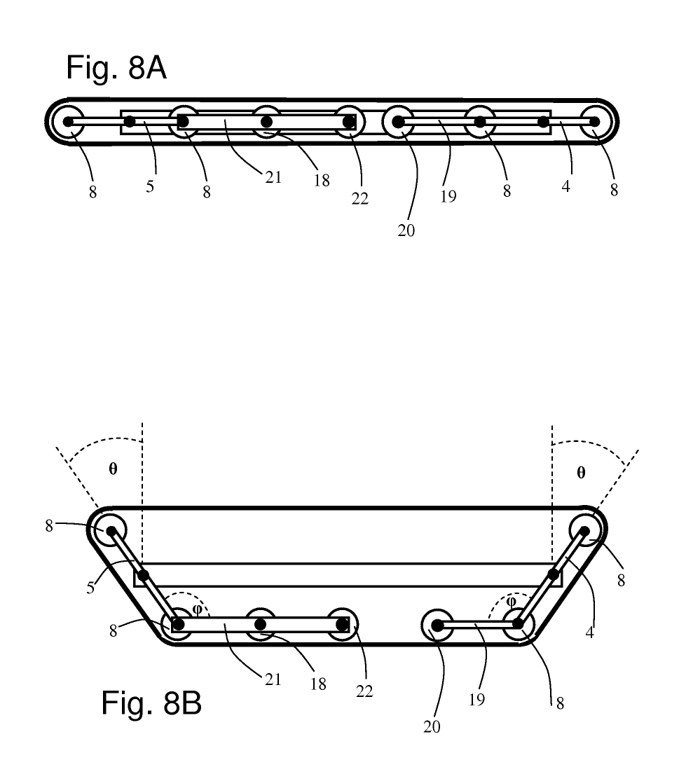

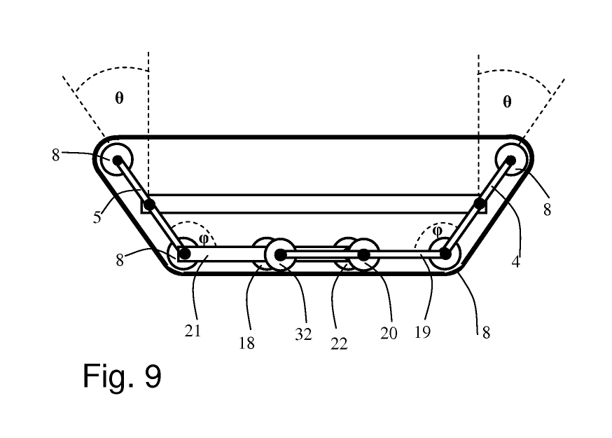

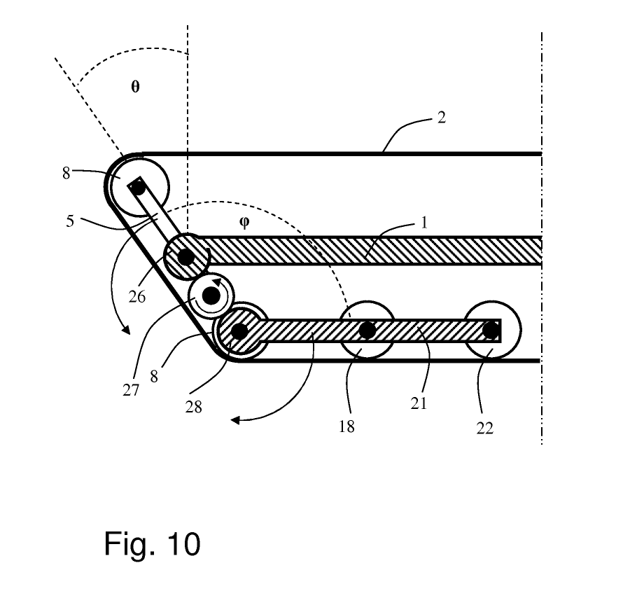

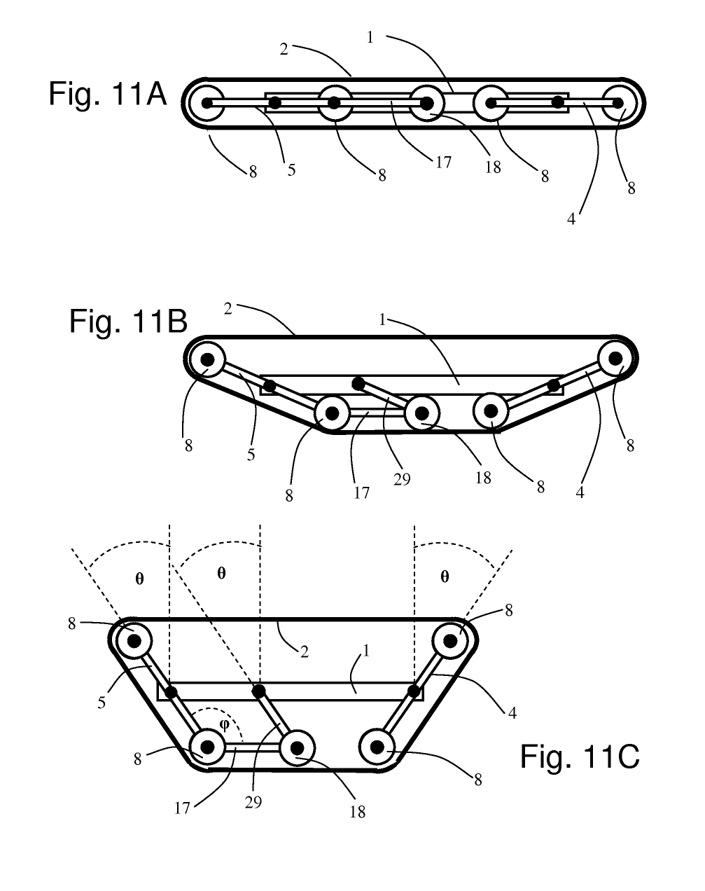

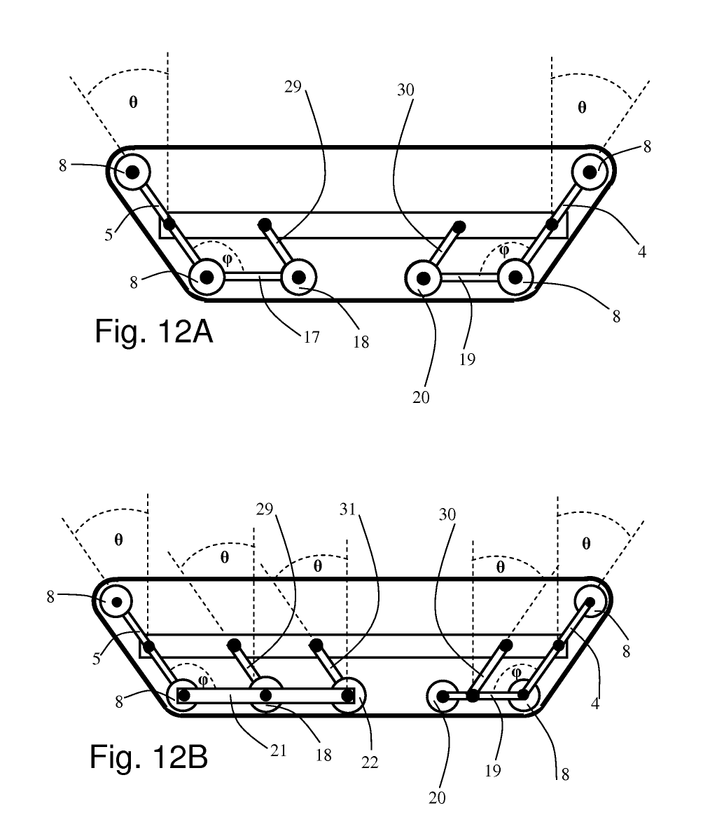

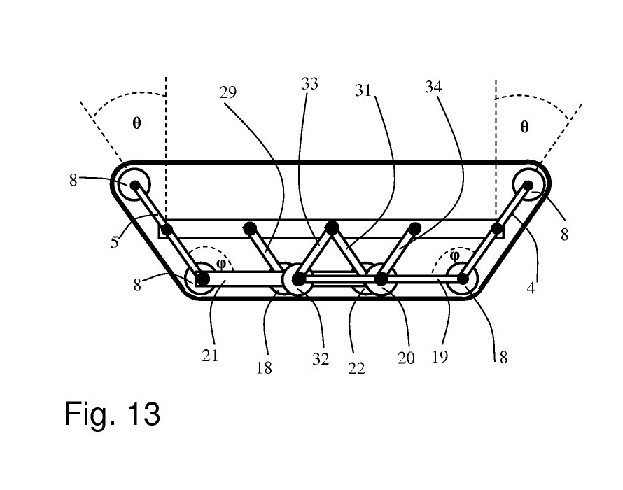

This self leveling capability is particularly advantageous in applications where a pan-tilt weapon or camera turret is mounted on the vehicle and where it is desirable to match the plane of rotation of the turret with the horizon. The self leveling capability results from the ability of the polymorphic track system to independently change the shape of the left and right tracks, enabling level keeping on rough or inclined terrain. FIG. 4A shows the vehicle in a tilted position due to uneven terrain. FIG. 4B shows the results of using the polymorphic track system for level keeping.

FIG. 5A and FIG. 5B show one possible embodiment of a mechanism by which power can be delivered to independently to both actuate an arm and also drive a track, i.e. a mechanism by which rotational energy can be delivered independently, to one of the actuated arms, and also to a track or belt which is supported by the sprockets or wheels mounted on said arm. This enables the speed and steering of the vehicle to be controlled independently of the track shape. FIG. 5A shows a side view of this mechanism and FIG. 5B shows a cut section through the mechanism, the cut section being as indicated in FIG. 5A. Features of one possible embodiment of the invention which are visible in these figures include:

1) the chassis of the vehicle;

4) actuated arm;

8) track sprockets, rotatably attached to actuated arms, that engage with and support the tracks (not shown);

9) a tubular or toroidal structure, rigidly attached to the actuated arm, and rotatably attached to the vehicle chassis about a transverse axis which is perpendicular to the plane of the actuated arms and tracks. By applying a torque to this structure, it is possible to cause the actuated arm to rotate, independently of the rotation of the drive shaft (11) which passes through the structure. Note that this embodiment is merely exemplary, and there are many other ways to deliver energy to an actuated arm as described later in this document, which are also included within the scope of the invention.

10) a sprocket rigidly attached to the tubular or toroidal structure of (9). In one possible exemplary embodiment of the invention, a chain and gear train are used to connect this sprocket to an electric motor, thus enabling the actuated arm to be rotated.

11) Drive shaft. In one possible embodiment of the invention, this passes through the tubular or toroidal structure (10) and delivers power to the track.

12), 13), 14), 15) Drive sprockets. These deliver power from the drive shaft to the track sprockets (8). In one possible embodiment of the invention, two chains (not shown in the figure) are used to connect these sprockets. In this exemplary embodiment, one chain engages with and functionally connects sprocket (12) to sprocket (15) and a second chain engages with and functionally connects sprocket (13) to sprocket (14), thus enabling torque to be transmitted from the drive shaft (11) to the shafts (16) on which the track sprockets (8) are mounted, thus driving any track which may be meshed with the teeth of the track sprockets. Note that a person skilled in the art could easily employ a variety of alternative mechanisms (e.g. a series of meshed gears) to deliver power from the drive shaft (11) to the track sprockets (8) without departing from the spirit of the invention, and these alternative mechanisms are also claimed as features of the present invention. 16) Track sprocket mounting shafts. These are shafts on which the track sprockets (8) are mounted, and which are rotatably connected to the arm (4).

FIGS. 6A, and 6B show simplified diagrams of two possible shapes that can be adopted by the right track of one possible embodiment of the present invention, as viewed from the right side of the vehicle. This inventive vehicle shares many common features with the polymorphic vehicle described in USPTO patent application Ser. No. 12/540,391. Common features which can be seen in FIGS. 6A and 6B include those labeled as 1-8. However, the inventive vehicle also comprises some additional inventive features, including a supplementary rear support arm on the right side of the vehicle (17), which is operably and rotatably connected to the rear actuated arm (5), and an additional supporting wheel (18) which is rotatably connected to the support arm (17).

FIG. 6B shows how the inventive vehicle can be operated so that, even in a trapezoidal configuration with high ground clearance, the weight of the vehicle is still supported by at least three wheels per track (in this example the front and rear wheels, 8, and the additional wheel, 18). To operate the vehicle correctly, it is necessary that both actuated arms (4) and (5) be positioned so that they always share an approximately common angle A with the vertical. Furthermore, additional mechanisms must be incorporated so that the supplementary support arm (17) be kept approximately parallel to the ground, by being maintained at an angle φ with the actuated arm (5) to which it is functionally connected, such that φ is always approximately equal to θ plus an additional 90 degrees, i.e. Φ=θ+90, with all angles being measured in degrees. The additional mechanisms that may be incorporated, in order to maintain this relationship of angles, might comprise gearing, springs, additional actuators or other mechanisms or combinations of mechanism as may be known to a person skilled in the art. One possible mechanism is shown in FIG. 10, however this is merely one possible embodiment of the invention, and all mechanisms by which the vehicle may be operated so as to approximately achieve the angular relationship of Φ=θ+90 are intended to be included within the scope of the present invention. Further examples of mechanical linkages that also maintain this angular relationship, are shown in FIGS. 11, 12, and 13.

FIGS. 7A, and 7B show simplified diagrams of another possible embodiment of the present invention. This example inventive vehicle shares many common features with the example shown in FIGS. 6A and 6B. However, the inventive vehicle of FIGS. 7A and 7B also comprises some additional inventive features, including a supplementary front support arm on the right side of the vehicle (19), which is operably and rotatably connected to the front actuated arm (4), and an additional supporting wheel (20) which is rotatably connected to the support arm (19).

FIG. 7B shows how this example of an inventive vehicle can be operated so that, even in a trapezoidal configuration with high ground clearance, the weight of the vehicle is still supported by at least four wheels per track (i.e. front and rear wheels, 8, and the additional wheels 18 and 20). To operate the vehicle correctly, it is necessary that both actuated arms 4) and 5) be positioned so that they always share an approximately common angle θ with the vertical. Furthermore, additional mechanisms must be incorporated so that the supplementary support arms (17) and (19) be kept approximately parallel to the ground by being maintained at an angle φ with the actuated arms (5) and (6) to which they are functionally connected, such that φ is always approximately equal to θ plus an additional 90 degrees, i.e. Φ=θ+90, with all angles being measured in degrees. The additional mechanisms that may be incorporated, in order to maintain this relationship of angles, might comprise gearing, springs, additional actuators or other mechanisms or combinations of mechanism as may be known to a person skilled in the art. FIGS. 10, 11, 12, and 13, show some possible mechanisms, however these are merely exemplary, and all mechanisms by which the vehicle may be operated so as to approximately achieve the angular relationship of Φ=θ+90 are intended to be included within the scope of the present invention.

FIGS. 8A, and 8B show simplified diagrams of another possible embodiment of the present invention. This example inventive vehicle shares many common features with the example shown in FIGS. 7A and 7B. However, the inventive vehicle of FIGS. 8A and 8B also comprises some additional inventive features, including a supplementary rear support arm on the right side of the vehicle (21), which is longer than the corresponding part (17) shown in FIGS. 7A and 7B, and also an additional supporting wheel (22). FIG. 8B shows how this example of an inventive vehicle can be operated so that, even in a trapezoidal configuration with high ground clearance, the weight of the vehicle is still supported by at least five wheels per track. It should be understood that this example is merely exemplary, and that a person skilled in the art might make variations and modifications by which arbitrarily long supplementary supporting arms could be used, connected to arbitrarily many supporting wheels, without departing from the spirit and scope of the invention. Any number of supporting wheels, rotatably connected to any length of supplementary supporting arm, are intended to be included within the scope of the invention.

FIG. 9 shows a simplified drawing of another possible embodiment of the present invention. The vehicle of FIG.9 is similar to that shown in FIG. 8, however in this example the front support arm (19) is longer than the equivalent arm in FIG. 8, and is rotatably attached to an additional wheel or track sprocket (32). Additionally, FIG. 9 illustrates the way in which the two support arms, (19) and (21), may occupy and move in separate vertical planes, so that their lengths can overlap. This is advantageous, because, if these two arms do not overlap when angle θ is large, then the central part of the track may be left with poor support when θ is small, because a large gap may separate the supporting wheels (22) and (32), with no wheels resting on the portion of track that lies between (22) and (32).

FIG. 10 shows a close-up drawing of the rear portion of one possible mechanism for realizing the vehicles shown in FIG. 8 and FIG. 9. FIG. 10 shows one possible means of ensuring that support arm (21) is kept parallel to the vehicle chassis, and that the angular relationship Φ=θ+90 is maintained, regardless of the angular position, θ, of rotating arm (5). Additional features which are visible in this figure include:

26) a gear, wheel or sprocket, or portion thereof, which is rigidly attached to the main body or chassis of the vehicle (1), but which is rotatably attached to the arm (5).

27) an idler wheel or sprocket which is freely rotatably attached to the arm (5) and which meshes and interfaces with sprocket (26) and sprocket (28), via gear teeth or a frictional interface or other means as may be known to a person skilled in the art.

28) a gear, wheel or sprocket, or portion thereof, which meshes and interfaces with sprocket (27). Sprocket (28) is rigidly attached to the support arm (21), but is rotatably attached to the rear rotatable arm (5).

As illustrated by the motion arrows in FIG. 10, if arm (5) is caused to rotate in a counter-clockwise sense, then the idler sprocket (27) will also be forced to rotate in a counter-clockwise sense because of its interaction with sprocket (26) which remains fixed on the chassis. The idler sprocket (27) interfaces with sprocket (28) and forces sprocket (28) and the arm (21) to which (28) is rigidly attached, to rotate in a clockwise sense. If sprockets (26) and (27) have the same diameters and tooth sizes, then arm (21) must always rotate so as to remain parallel to the chassis (1), regardless of the angle 0 adopted by arm (5).

FIGS. 11A, 11B and 11C show an alternative mechanism for maintaining a desirable angular relationship between rotating arms. FIGS. 11A, 11B and 11C show another inventive vehicle which is similar to that shown in FIGS. 6A and 6B. However, this vehicle uses an additional half-length rotating arm (29) to ensure that the relationship Φ=θ+90 is maintained. The half-length rotating arm (29) is rotatably attached at one end to the vehicle chassis (1), and is rotatably attached at the other end to the support arm (17). The lengths of the arms and the positions of the rotatable attachment points are designed so that part of the chassis (1), the lower half of rotating arm (5), the support arm (17) and the half-length rotating arm (29) form the four sides of a parallelogram, with ensures that arms (5) and (29) are maintained in parallel alignment with each other and support arm (17) is kept parallel with respect to the chassis (1) and thus horizontal with respect to the ground plane that the vehicle may be resting on.

FIGS. 12A and 12B show additional examples of extensions and variations of the mechanical linkage shown in FIGS. 11A, 11B, and 11C. In 12A, a supplementary support arm (19), supporting wheel (20), and half-length rotating arm (30) have been added, ensuring that the weight of the vehicle is always distributed over at least 4 supporting wheels on each track (i.e. at least 8 wheels if the vehicle possesses both a left and a right track). The addition of half-length rotating arm (29) ensures that support arm (17) remains parallel to the plane of the chassis (1), and parallel to a ground plane upon which the vehicle might be resting. The addition of half-length rotating arm (30) ensures that support arm (19) remains parallel to the plane of the chassis (1), and parallel to a ground plane upon which the vehicle might be resting. Therefore the use of arms (29) and (30) enables some of the weight of the vehicle to be delivered to and born by supporting wheels (18) and (20), without the need for the mechanism shown in FIG. 10, or other mechanisms.

FIG. 12B shows another example of the present invention, in which the support arm (21) carries multiple supporting wheels (18) and (22), and is maintained parallel to the chassis by multiple half-length rotating arms (29) and (31). Furthermore, FIG. 12B illustrates that half-length rotating arms, e,g, (29), (30), (31), do not necessarily have to be rotatably attached to support arms, e.g. (21) or (19), at the same location where supporting wheels are attached. For example, arm (30) attaches to arm (19) at a location where no supporting wheel is attached. In general, an arbitrarily many half-length rotating arms, e.g. similar to (29), (30), or (31), can be attached to support arms, e.g. (20), at arbitrary locations along those arms. All such numbers of half-length rotating arms, and all such attachment locations on support arms, are intended to be included within the scope of the invention.

FIG. 13 show a prototype embodiment of a polymorphic actuated track mechanism, which is similar to that depicted schematically in FIGS. 11 and 12. In this example, a long support arm (19), rotatably attached to wheels or track sprockets (20) and (32), is connected to the chassis (1) via half length rotating arms (33) and (34). Similarly, a long support arm (21), rotatably attached to wheels or sprockets (32) and (20), is connected to the chassis via half length rotating arms (29) and (31). FIG. 13 shows how an embodiment of the inventive vehicle can be built, wherein two support arms, (19) and (21) occupy and move within parallel but separate vertical planes, so that their lengths can overlap, with arm (21) passing behind arm (19). This is advantageous, because, if these two arms do not overlap when angle θ is large, then the central part of the track may be left with poor support when θ is small, because a large gap may separate the supporting wheels (22) and (32), with no wheels resting on the portion of track that lies between (22) and (32).

### SUMMARY OF THE INVENTION

The present invention comprises a polymorphic tracked vehicle and methods for its operation. Embodiments of a polymorphic tracked vehicle may include manned or unmanned (e.g. autonomous, semi-autonomous or tele-operated robot) tracked vehicles, built to a variety of sizes or scales. An important feature of the invention is a mechanism which enables the shape of the vehicle's tracks to be modified during operation, but which simultaneously enables the weight of the vehicle to be distributed over many (more than two) supporting wheels on each track, regardless of whatever configuration or shape of the tracks that may be selected by the operator.

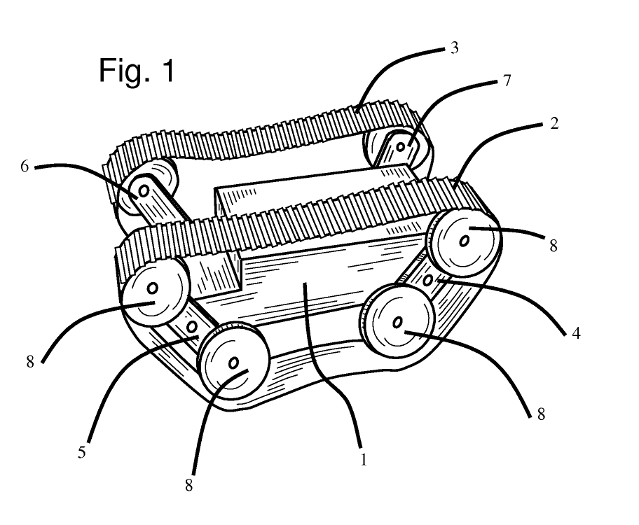

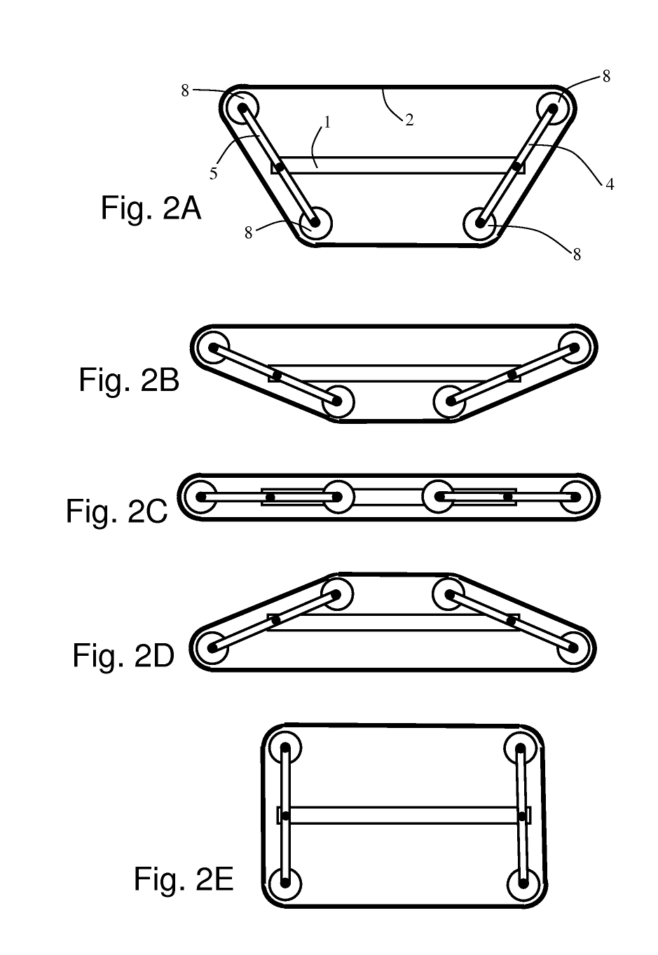

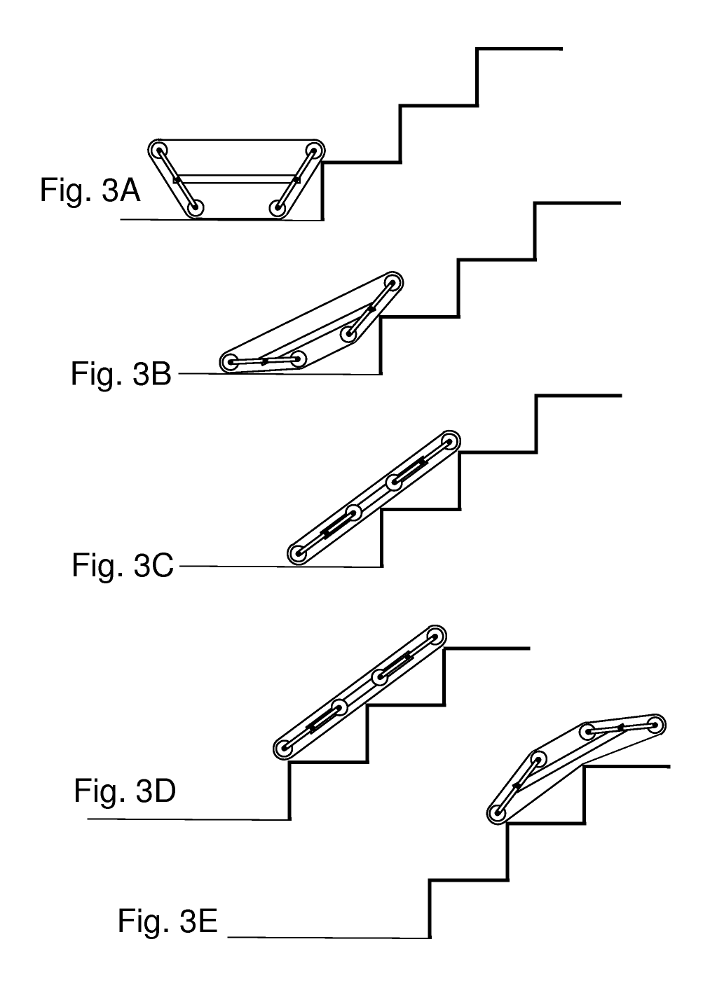

A polymorphic tracked vehicle, as shown in FIG. 1, was prototyped in 2008 and is currently the subject of a pending patent application, USPTO Ser. No. 12/540,391. A disadvantage of this design is that, in most configurations of the track, the weight of the vehicle is distributed between only two supporting wheels per track. In contrast, the present invention provides an improved polymorphic track mechanism and method of operation, by which the weight of the vehicle may be distributed between arbitrarily many wheels per track, regardless of the configuration or track shape that is selected by the operator.

In exemplary embodiments of the present invention, a polymorphic tracked vehicle comprises a chassis with left and right sides, and a left and right track. Each track extends around at least five wheels or “track sprockets”, at least one of which is powered so as to enable the track to be driven. The at least five wheels support the track so that it always forms the approximate shape of an isosceles trapezoid, having a wheel center being located close to each vertex of said trapezoid. The at least five wheels include a pair at the front of the vehicle and a pair at the rear of the vehicle. Each such pair is mounted on opposite ends of an arm which can be rotated about its center, the axis of rotation being perpendicular to the plane of the track and wheels. Additionally, at least one of these rotating arms should be rotatably attached to a supplementary support arm which is fitted with additional supporting wheels or track sprockets. Rotating these arms causes the shape of the trapezoidal track locus to be altered (moving the upper and lower sides of the trapezoidal track either closer together or further apart and thereby raising or lowering the chassis of the vehicle relative to the ground). Furthermore, by using appropriate mechanisms as may be known to a person skilled in the art, the supplementary arms may be controlled so that they always remain parallel to the top and bottom edges of the trapezoidal track shape. One approach is to use mechanisms which can exert a torque on the supplementary arms at the rotating joints where they attach to the rest of the vehicle, thereby transmitting load forces to the supporting wheels mounted on said supplementary arms, and thereby enabling some of the weight of the vehicle to be distributed to said supporting wheels. Another approach is to use at least one additional arm, rotatably attached to the chassis at one end, and rotatably attached to the supplementary support arm at the other end, so as to form a parallelogram structure which ensures that the supplementary support arm is maintained in parallel alignment with the chassis of the vehicle, and with a ground plane upon which the vehicle may be resting.

### DETAILED DESCRIPTION OF A PREFERRED EMBODIMENT OF THE INVENTION

Some features of the polymorphic tracked vehicle with supplementary support arms include:
A main section, body or chassis including a main frame with left and right sides, (1).
A pair of parallel tracks or belts, operably attached to the left, (2), and right, (3) sides of the vehicle.
A pair of arms on each side of the vehicle, comprising front (4) and rear (5) arms on the right side of the vehicle (the right pair of arms), and front (7) and rear (6) arms on the left side of the vehicle (the left pair of arms), each arm being rotatably attached to the chassis about a transverse axis allowing rotation of the arm about the transverse axis (an axis perpendicular to the plane of the arms and the track which they support).
An actuation system consisting of a transmission, actuator, and linkage to each arm which enables each pair of arms to be rotated in synchronous motion.
Rotatably attached to at least one of the front or rear arms (4), (5), (6) or (7), a supplementary support arm (17).
Rotatably attached to each such arm (including front, rear and supplementary arms), at least two wheels or sprockets (8), at least one such wheel or sprocket located near to each end of the arm. These wheels interface with and support the tracks, i.e. each track belt extends around the wheels (mounted on front, rear and supplementary arms) on its side of the vehicle. We sometimes refer to these wheels or sprockets as “track sprockets”.
For each supplementary arm, either: firstly, a mechanism which can exert a torque on said arm, causing it to either rotate or resist rotation relative to the front or rear arm to which it is rotatably attached, or, secondly, an additional rotating arm, rotatably attached at one end to the chassis, and at the other end to the supplementary arm, so as to maintain the supplementary arm in parallel alignment with the chassis.
At least one drive system and preferably two independent drive systems for driving the left and right tracks in order to propel the vehicle, each such drive system consisting of at least one motor, engine or other actuator, and associated transmissions and linkages, to cause at least one of the wheels or “track sprockets” to rotate, thereby driving the track which that wheel or track sprocket supports and with which it interfaces. There are many alternative mechanisms by which a person skilled in the art could arrange a power source to deliver independent power to each track. For example, two independent motors could be used, one for the right track and one for the left track. Alternatively, a single engine or motor could be used in conjunction with a system of clutches or other transmission system to enable the left and right tracks to be controlled independently. Alternatively, multiple motors could be used to power more than one wheel or track sprocket on each side of the vehicle. All such methods are intended to be included within the scope of the present invention.

In one possible embodiment of the invention, a sprocket or toothed component (26) is rigidly attached to the main body or chassis (1) so that it cannot rotate with respect to the chassis. At least one of the actuated arms (5) on each side of the vehicle is rotatably connected to the chassis in such a way that the axis of rotation passes through the centre of the sprocket or toothed component (26), so that said actuated arm is free to rotate with respect to the chassis, and can thus rotate independently of the sprocket (26) which is rigidly attached to the chassis. Motors, actuators or other mechanisms can operate on said rotatable attachment, in order to cause the arm (5) to rotate with respect to the chassis (1). If the rotational attachment structure is toroidal (i.e. tubular), then additional shafts (11) may pass through its center in order to deliver power to the tracks, e.g. via chains interfaced with sprockets (12), (13), (14), (15) or via other mechanisms as may be known to a person skilled in the art.

The teeth of sprocket (26) are meshed with those of sprocket (27) which is rotatably attached to the arm (5) so that it can rotate independently of the arm. Thus, if arm (5) is caused to rotate relative to the chassis (1), the teeth of sprocket (26) will act on the teeth of sprocket (27) such that sprocket (27) rotates with respect to arm (5). Further, if the teeth of sprocket (27) are meshed with the teeth of another sprocket (28), then this sprocket also will be caused to rotate relative to arm (5), whenever arm (5) is caused to rotate relative to the chassis (1). Sprocket (28) is rotatably attached to arm (5), but is rigidly attached to supplementary support arm (17). Thus, when sprocket (28) rotates relative to arm (5), supplementary support arm (17) will also rotate relative to arm (5). Furthermore, because of the kinematic relationship by which meshed gears interact, sprocket (28) and the attached arm (17) must always rotate in an opposite sense to the rotation of sprocket (27), and thereby also in an opposite sense to any rotation of arm (5). Thus, this is an embodiment of one example mechanism, by which the supplementary support arm (17) can be caused to always rotate in an opposite sense to any rotation of arm (5). Thus this is a mechanism by which arms (4) and (5) can be rotated to cause a track to adopt a variety of trapezoidal shapes, meanwhile the supplementary support arm (17) is synchronously rotated so that it always lies along the bottom edge of the trapezoid. Since this mechanism is capable of delivering torques to one end of arm (17), loads can be delivered to arm (17) thereby distributing the weight of the vehicle between wheels (8) and any additional supporting wheels (18) which may be mounted on the supplementary support arm (17).

In another possible embodiment of the invention, a half-length rotating arm (29) is rotatable attached at one end to the chassis (1), and rotatably attached at the other end to supplementary support arm (17), in such a way that a parallelogram is formed by the lower half of arm (5), arm (17), arm (29) and a part of the chassis (1). Thus, if arm (5) is actuated causing it to rotate, it follows that arm (29) will also rotate by the same amount, causing arm (17) to be maintained in parallel alignment with the vehicle chassis (1) and with a ground plane on which the vehicle may be resting.

It should be understood that the embodiments described herein are merely exemplary and that a person skilled in the art may make many variations and modifications thereto without departing from the spirit and scope of the present invention. All such variations and modifications are intended to be included within the scope of the invention.

### BENEFITS OF THE INVENTION

The invention comprises a polymorphic tracked vehicle. This has benefits over conventional tracked vehicles, in that the tracks may be actuated to change their shape during operation. This enables the operator to vary the tradeoffs between ground, clearance and wheel-base length and stability, while the vehicle is in use. It also enables the vehicle to negotiate extreme obstacles such as steep stair climbing, and additionally enables self-leveling of the vehicle when on inclined terrain. The present invention offers additional advantages over previous polymorphic vehicle designs (e.g. the Ser. No. 12/540,391 vehicle), in that it provides a means by which the vehicle can be supported by at least three, and preferably many, road wheels per track, whereas the Ser. No. 12/540,391 vehicle often has its weight distributed between just two wheels per track in many modes of operation.

The embodiments of the invention in which we claim an exclusive property or privilege include:

1. A polymorphic vehicle, comprising:
a) a chassis including a main body with left and right sides;
b) a left pair of actuated rotating arms on the left side of the vehicle, comprising front and rear arms, each arm being rotatably attached to the chassis about a transverse axis, allowing rotation of the arm about said transverse axis;
c) a right pair of actuated rotating arms on the right side of the vehicle, comprising front and rear arms, each arm being rotatably attached to the chassis about a transverse axis, allowing rotation of the arm about said transverse axis;
d) for each pair of arms, an actuation system consisting of a transmission, actuator, and linkage, which enables said pair's front and rear arms to be rotated in synchronous motion;
e) rotatably attached to each such arm, at least two wheels or track sprockets, at least one such wheel or track sprocket located near to each end of said arm;
f) rotatably attached to at least one end of at least one of said actuated rotating arms, an additional supplementary supporting arm;
g) at least one mechanism by which said supplementary supporting arm can be rotated, so that it is maintained in parallel alignment with the vehicle chassis, and may also be kept in parallel alignment with a ground plane upon which the vehicle may be resting, regardless of the angle of rotation of the actuated rotating arm to which said supplementary supporting arm is rotatably attached;
h) rotatably attached to said supplementary supporting arm, at least one wheel or track sprocket;
i) at least one drive system and preferably two independent drive systems, comprising at least one motor, engine or other actuator, and associated transmissions and linkages, to cause at least one of the wheels or track sprockets on each side of the vehicle to rotate.

2. A polymorphic vehicle as claimed in claim 1, with the addition of a right and left track belt, extending around, supported by and operably interfacing with the wheels or track sprockets mounted on the right and left sides of the vehicle respectively, such that causing a wheel or track sprocket to rotate will drive the track belt with which said wheel or track sprocket interfaces.

3. A polymorphic vehicle as claimed in claim 1, wherein the mechanism for maintaining parallel alignment of at least one supplementary supporting arm with respect to the chassis, comprises at least one half-length rotating arm, said half-length rotating arm rotatably attached to the chassis and rotatably attached to said supplementary supporting arm, so that part of at least one arm of the left or right pair of actuated rotating arms, part of the chassis, part of the supplementary supporting arm, and the half-length rotating arm, form the four sides of a parallelogram.

4. A polymorphic vehicle as claimed in claim 1, wherein the mechanism for maintaining parallel alignment of the supplementary supporting arm with respect to the chassis, comprises a series of meshed gears, motors, actuators, or other such mechanisms which may cause a torque to be exerted at the joint where the supplementary supporting arm is rotatably attached to one of the front or rear rotating arms of the vehicle.

5. A polymorphic vehicle as claimed in claim 1, wherein the mechanism for maintaining parallel alignment of at least one supplementary supporting arm with respect to the chassis, comprises a series of meshed gears, chains, or other such mechanisms, whereby a kinematic relationship is enforced between said supplementary supporting arm and the front or rear actuated rotating arm to which it is attached, said kinematic relationship ensuring that said supplementary supporting arm is maintained in parallel alignment with the vehicle chassis, regardless of the angle of rotation of said actuated rotating arm.

6. A polymorphic vehicle as claimed in claim 1, further including a remote control unit, operably connected to the vehicle.

7. A polymorphic vehicle as claimed in claim 1, further including a motorized pan-tilt platform, mounted on the chassis.

8. A polymorphic vehicle as claimed in claim 1, further including a robotic arm or other manipulating device mounted on the chassis.

9. A polymorphic vehicle as claimed in claim 1, further including a firearm, disruptor or other weapons system, mounted on the chassis.

10. A polymorphic vehicle as claimed in claim 1, further including accessories attached thereto, wherein said accessories are chosen from the group consisting of image capture devices, visible light cameras, infra red cameras, time of flight cameras, microphones, range finders, lasers, bio-chemical sensors, radiation sensors, x-ray equipment, disrupters; and also including wireless equipment, standard sensors and combinations thereof.

11. A polymorphic vehicle as claimed in claim 1, wherein at least one wheel or track sprocket is connected to the vehicle via a suspension structure or mechanism which is compliant to impact, thereby providing a springy, or shock absorbing suspension for said vehicle.

12. A polymorphic tracked vehicle as claimed in claim 2, further including a track tensioning device.

13. A polymorphic tracked vehicle as claimed in claim 1, comprising both front and rear supplementary supporting arms on at least one side of the vehicle, wherein said supplementary supporting arms are constrained to occupy parallel vertical plains, so that said supplementary supporting arms may overlap by some portion of their length in some configurations of the polymorphic vehicle.

14. A polymorphic vehicle as claimed in claim 1, wherein at least one arm is rotatably connected to the chassis via a rotatable toroidal structure, whereby power can be delivered to at least one wheel or track sprocket mounted on said arm, via a rotating shaft which passes through the center of said toroidal structure, such that said shaft and said toroidal structure may rotate independently of each other.

15. A polymorphic vehicle as claimed in claim 1, wherein pistons or other linear actuators are functionally connected between the chassis and at least one of the actuated rotating arms or supplementary supporting arms, thereby providing a means of causing said actuated rotating arms to rotate with respect to said chassis.

16. A polymorphic vehicle as claimed in claim 1, wherein at least one motor is mounted on at least one rotatable arm or supporting arm, and wherein said motor is functionally connected with at least one wheel or track sprocket mounted on said arm, in order to deliver rotational power to said wheel or track sprocket.

17. A method for operating a polymorphic vehicle, having at least one pair of front and rear actuated rotating arms, and at least one supplementary supporting arm rotatably attached to at least one of said actuated rotating arms, wherein the at least one supplementary supporting arm is controlled so as to maintain parallel alignment with the vehicle chassis, or the ground upon which the vehicle may be resting, regardless of the angle of rotation of the actuated rotating arm to which said supplementary arm may be attached.

18. A method for operating a polymorphic vehicle, as claimed in claim 17, wherein wheels or track sprockets are rotatably attached to actuated rotating arms and any supplementary supporting arms, so as to cause the vehicle to climb a series of stairs having a rise in elevation at the first stair and at each subsequent stair, comprising:
a) rotating the actuated rotating arms so that the highest wheel or track sprocket, or the part of any track or belt which may be supported by said wheel or track sprocket, is raised at least as high as the rise of the first stair;
b) driving at least one wheel or track sprocket, so as to propel the vehicle towards the stairs, until at least one wheel or track sprocket, or part of any track or belt which may be supported by said wheel or track sprocket, contacts the first stair;
c) rotating the actuated rotating arms on at least one side of the vehicle in order extend the wheeled base of the vehicle;
d) driving at least one of the wheels or track sprockets so as to propel the vehicle up the series of stairs.

19. A method for operating a polymorphic tracked vehicle, as claimed in claim 17, comprising synchronously rotating the front and rear actuated rotating arms on at least one side of the vehicle, thereby causing a change in the height of at least one side of the main body of the vehicle above the ground.

20. A method for operating a polymorphic tracked vehicle, as claimed in claim 19, wherein the actuated rotating arms on the left side of the vehicle and the actuated rotating arms on the right side of the vehicle are rotated by different amounts, thereby causing a change in height above the ground of the left side of the vehicle's main body which is different from the change in height above the ground of the right side of the vehicle's main body, thereby changing the level of incline of the vehicle's main body relative to the ground, and thereby providing a means for self leveling of the vehicle when it is on inclined or uneven terrain.
